(19) United States
(12) Patent Application Publication
(10) Pub. No.: US 2007/0207324 A1
(43) Pub. Date: Sep. 6, 2007

(54) METHOD FOR MANUFACTURING AN ANTI-SCRAPE PLASTIC SURFACE AND THE ANTI-SCRAPE PLASTIC SURFACE

(76) Inventor: Chieh Nan LIN, Taichung City (TW)

Correspondence Address: SINORICA, LLC, 528 FALLSGROVE DRIVE, ROCKVILLE, MD, 20850, US

(21) Appl. No.: 11/675,879

(22) Filed: Feb. 16, 2007

(30) Foreign Application Priority Data
Mar. 3, 2006 (TW) 095107232

(51) Int. Cl. B32B 27/40

(52) U.S. Cl. 428/423.1; 428/409; 428/195.1

(57) ABSTRACT

A method for manufacturing an anti-scrape plastic surface and the anti-scrape plastic surface. The anti-scrape plastic surface includes a plastic article with a predetermined size and a cover layer which is a hardening agent painted on and adhered to at least one surface of the article. The method for manufacturing the anti-scrape plastic surface includes steps of preparing a plastic article with a predetermined size, painting a hardening paint on at least one surface of the article and heating and pressurizing the hardening paint to bond the paint with the surface of the article to form an anti-scrape surface on the article.

### BACKGROUND OF THE INVENTION

The present invention is related to a method for manufacturing an anti-scrape surface and the anti-scrape surface, and more particularly to a method for manufacturing an anti-scrape plastic surface and the anti-scrape plastic surface.

There are many kinds of plastics. In general, the plastics are plastic and lightweight. In addition, the plastics are waterproof, heatproof, antishock, acidproof and alkaliproof. Different kinds of plastics have different performances and are applicable to different fields. Basically, depending on the heating properties, the plastics can be divided into thermosetting type and thermoplastic type.

Nowadays, plastics are widely applied to various products such as daily products, electric products, containers, package boxes, posts, tabs, etc. Especially, it is trend to use plastic money such as credit card, financial card, etc. instead of the cash. These products are mostly made of PET (Polyethylene terephthalate generally used to manufacture beverage bottles), PVC, PP or MILA. These plastic products provide great conveniences for people in daily life. However, the surface of the plastic product is weak, that is, has low hardness. During use, the surface of the plastic product is often incautiously scraped or abraded. As a result, the figure printed on the plastic product is apt to peel off to lead to a poor appearance and shorten the using life of the plastic product. Consequently, it is necessary to frequently replace the used plastic product with a new one. This results in problems of environmental protection.

In the case that an anti-scrape plastic PC with higher hardness is used as the material of the plastic product, the surface of the plastic product will have better strength without being scraped or abraded. However, the cost for the PC material is about ten times the cost for PET, PVC and PP. Therefore, the manufacturing cost is relatively high.

### SUMMARY OF THE INVENTION

It is therefore a primary object of the present invention to provide a method for manufacturing an anti-scrape plastic surface and the anti-scrape plastic surface. The anti-scrape plastic surface has better strength and longer using life.

It is a further object of the present invention to provide the above method for manufacturing the anti-scrape plastic surface, by which the cost for the anti-scrape plastic surface is lowered.

According to the above objects, the anti-scrape plastic surface of the present invention includes a plastic article with a predetermined size and a cover layer which is a hardening agent painted on and adhered to at least one surface of the article. The method for manufacturing the anti-scrape plastic surface includes steps of preparing a plastic article with a predetermined size, painting a hardening paint on at least one surface of the article and heating and pressurizing the hardening paint to bond the paint with the surface of the article.

The present invention can be best understood through the following description and accompanying drawings wherein:

### BRIEF DESCRIPTION OF THE DRAWINGS

FIG. 1 is a perspective exploded view of the anti-scrape plastic surface of the present invention; and

FIG. 2 is a flow chart of the manufacturing method of the present invention.

### DETAILED DESCRIPTION OF THE PREFERRED EMBODIMENTS

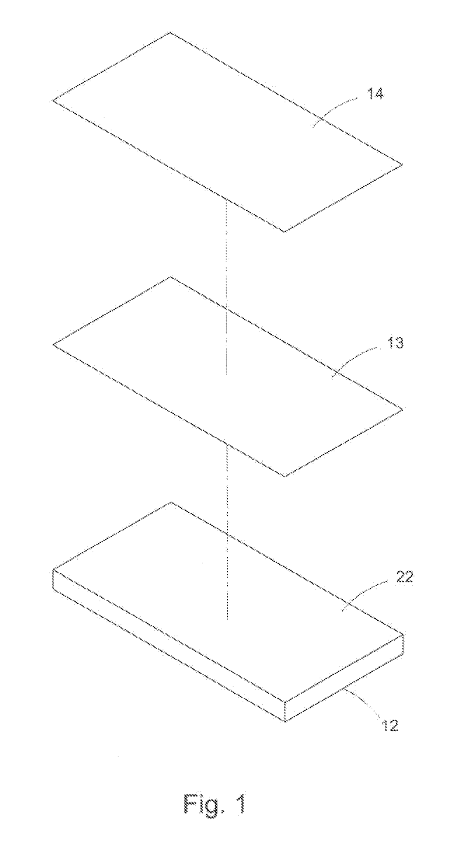

Please refer to FIG. 1. The anti-scrape plastic surface of the present invention includes an article 12 and a cover layer 14.

The article 12 is a quadrangular or polygonal sheet or a solid body made of plastic material with predetermined size and shape. The article 12 is made of a plastic material such as PVC, PET (Polyethylene terephthalate), PP or MILA, etc.

The cover layer 14 is a hardening agent painted on and adhered to at least one surface 22 of the article 12 for preventing the surface 22 from being scraped or abraded. The cover layer 14 is made of a compound of a PU material such as PU and an isocyanate material such as polyisocyanate, which are mixed and hardened to form the compound.

The plastic article 12 is coated with the hardening cover layer 14 to achieve an anti-scrape plastic blank board which can be manufactured at low cost. The blank board can be used to manufacture different commercial products.

The above structure can further include a figure layer 13 printed on the surface 22 of the article 12 between the article 12 and the cover layer 14. Such structure is applicable to various products such as package boxes, posts, tabs, financial cards, credit cards, etc. By means of the anti-scrape surface, the plastic product will have better appearance and longer using life.

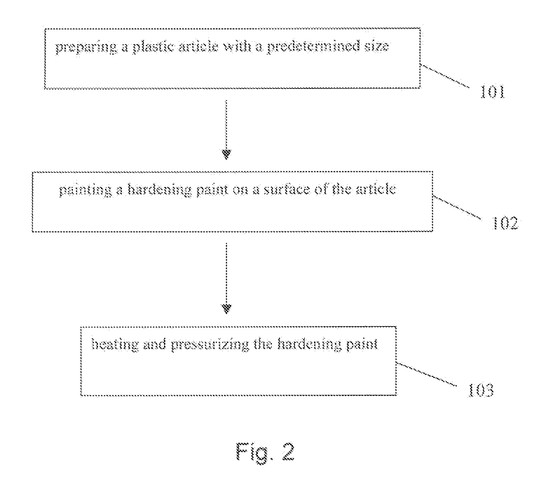

Referring to FIG. 2, the method for manufacturing the anti-scrape plastic surface of the present invention includes steps of:

step 101: preparing a plastic article 12 with a predetermined size;

step 102: painting a hardening paint on a surface 22 of the article 12; and

step 103: heating and pressurizing the hardening paint to bond the paint with the surface 22 of the article 12.

By means of heating and pressurizing the paint, the paint is evenly and planely painted over the surface of the article 12 so as to reduce the roughness thereof. In addition, the hardening paint forms a harder surface of the article 12 as an anti-scrape surface.

Prior to step 102, the method of the present invention further includes a step of printed a figure layer 13 on the surface 22 of the article 12 between the article 12 and the hardening paint.

In step 103, the paint is pressurized by means of a mirror-face steel board, whereby the surface of the article 12 is like a mirror face to achieve a beautiful appearance. The pressurizing pressure is higher than 100 kg/cm² and the heating temperature is higher than 60° C.

The paint is made of a compound of a PU material such as PU and an isocyanate material such as polyisocyanate, which are mixed and hardened to form the compound.

The above embodiments are only used to illustrate the present invention, not intended to limit the scope thereof. Many modifications of the above embodiments can be made without departing from the spirit of the present invention.

What is claimed is:

1. An anti-scrape plastic surface comprising:
an article made of plastic material with a predetermined size; and
a cover layer which is a hardening agent painted on and adhered to at least one surface of the article.

2. The anti-scrape plastic surface as claimed in claim 1, further comprising a figure layer printed on the surface of the article between the article and the cover layer.

3. The anti-scrape plastic surface as claimed in claim 1, wherein the article is selected from the group consisting of PVC, PET, PP and MILA material.

4. The anti-scrape plastic surface as claimed in claim 2, wherein the article is selected from the group consisting of PVC, PET, PP and MILA material.

5. The anti-scrape plastic surface as claimed in claim 1, wherein the cover layer is made of a compound of a PU material and an isocyanate material.

6. The anti-scrape plastic surface as claimed in claim 2, wherein the cover layer is made of a compound of a PU material and an isocyanate material.

7. A method for manufacturing an anti-scrape plastic surface, comprising steps of:
A. preparing a plastic article with a predetermined size;
B. painting a hardening paint on at least one surface of the article; and
C. heating and pressurizing the hardening paint.

8. The method as claimed in claim 7, wherein prior to step B, the method further comprises a step of printed a figure layer on the surface of the article between the article and the hardening paint.

9. The method as claimed in claim 7, wherein in step C, the paint is pressurized by means of a mirror-face steel board.

10. The method as claimed in claim 8, wherein in step C, the paint is pressurized by means of a mirror-face steel board.

11. The method as claimed in claim 7, wherein in step C, the pressurizing pressure is higher than 100 kg/cm².

12. The method as claimed in claim 8, wherein in step C, the pressurizing pressure is higher than 100 kg/cm².

13. The method as claimed in claim 7, wherein in step C, the heating temperature is higher than 60° C.

14. The method as claimed in claim 8, wherein in step C, the heating temperature is higher than 60° C.

15. The method as claimed in claim 7, wherein in step A, the article is selected from the group consisting of PVC, PET, PP and MILA material.

16. The method as claimed in claim 8, wherein in step A, the article is selected from the group consisting of PVC, PET, PP and MILA material.

17. The method as claimed in claim 7, wherein in step B, the paint is made of a compound of a PU material and an isocyanate material.

18. The method as claimed in claim 8, wherein in step B, the paint is made of a compound of a PU material and an isocyanate material.
